(19) United States
(12) Patent Application Publication
(10) Pub. No.: US 2025/0306186 A1
(43) Pub. Date: Oct. 2, 2025

(54) Compensation for differential nonlinearity in time-of-flight sensing

(71) Applicant: Apple Inc., Cupertino, CA (US)

(72) Inventors: Vyshakh Sanjeev, San Francisco, CA (US); Shingo Mandai, Mountain View, CA (US); Cristiano L. Niclass, San Jose, CA (US); Rahmi Hezar, San Jose, CA (US)

(21) Appl. No.: 19/000,770

(22) Filed: Dec. 24, 2024

Related U.S. Application Data
(60) Provisional application No. 63/570,838, filed on Mar. 28, 2024.

(51) Int. Cl. G01S 7/4865; G01S 7/4863

(52) U.S. Cl. CPC G01S 7/4865; G01S 7/4863

(57) ABSTRACT

Optical sensing apparatus includes a radiation source, which directs a series of optical pulses toward a target scene with a pulse repetition interval (PRI) equal to a first number p of sampling intervals defined by a sample clock. A first array of single-photon detectors output electrical pulses in response to photons reflected from the target scene that are incident thereon. A second array of time-to-digital converters (TDCs) detect the electrical pulses that are output by respective groups of the single-photon detectors in each of a sequence of the sampling intervals in a succession of sampling frames and output respective times of arrival of the electrical pulses. Each sampling frame contains a second number m of the sampling intervals such that p and m are co-prime. Control logic receives and aggregates the times of arrival output by the TDCs into a histogram.

### CROSS-REFERENCE TO RELATED APPLICATION

This application claims the benefit of U.S. Provisional Patent Application 63/570,838, filed Mar. 28, 2024, whose disclosure is incorporated herein by reference.

### FIELD

The present invention relates generally to systems and methods for depth mapping, and particularly to time-of-flight sensing.

### BACKGROUND

Time-of-flight (TOF) imaging techniques are used in many depth mapping systems (also referred to as 3D mapping or 3D imaging systems). In direct TOF techniques, a light source, such as a pulsed laser, directs pulses of optical radiation toward the scene that is to be mapped, and a high-speed detector senses the time of arrival of the radiation reflected from the scene. The depth value at each pixel in the depth map is derived from the difference between the emission time of the outgoing pulse and the arrival time of the reflected radiation from a corresponding point in the scene, which is referred to as the “time of flight” of the optical pulses.

Single-photon avalanche diodes (SPADs), also known as Geiger-mode avalanche photodiodes (GAPDs), are detectors capable of capturing individual photons with high time-of-arrival resolution, of the order of few tens of picoseconds. They may be fabricated using dedicated semiconductor processes or with standard CMOS technologies. Arrays of SPAD sensors, fabricated on a single chip, are used in some 3D imaging cameras.

U.S. Pat. No. 11,500,094, whose disclosure is incorporated herein by reference, describes sensing apparatus, which includes a radiation source, which emits pulses of optical radiation toward multiple points in a target scene. A receiver receives the optical radiation that is reflected from the target scene and outputs signals that are indicative of respective times of flight of the pulses to and from the points in the target scene. Processing and control circuitry selects a first pulse repetition interval (PRI) and a second PRI, greater than the first PRI, from a permitted range of PRIS, drives the radiation source to emit a first sequence of the pulses at the first PRI and a second sequence of the pulses at a second PRI, and processes the signals output in response to both the first and second sequences of the pulses in order to compute respective depth coordinates of the points in the target scene.

U.S. Patent Application Publication 2022/0244391, whose disclosure is incorporated herein by reference, describes optical sensing apparatus, which includes radiation source, which directs a series of optical pulses toward a target scene. A first array of single-photon detectors receives optical radiation that is reflected from the target scene and outputs electrical pulses in response to incident photons. A second array of counters aggregates and counts the electrical pulses output by the single-photon detectors over respective periods indicated by respective gating signals applied to the counters. Control logic applies the respective gating signals to the counters, in each of a sequence of image frames, so as to cause different ones of the counters to aggregate and count the electrical pulses output by one or more of the single-photon detectors over different, respective gating intervals relative to each of the optical pulses, and to sum the frame histograms generated with different temporal offsets so as to compute and output a cumulative histogram.

### SUMMARY

Embodiments of the present invention that are described hereinbelow provide improved apparatus and methods for optical sensing.

There is therefore provided, in accordance with an embodiment of the invention, optical sensing apparatus, including a radiation source, which is configured to direct a series of optical pulses toward a target scene with a pulse repetition interval (PRI) equal to a first number p of sampling intervals defined by a sample clock. A first array of single-photon detectors is configured to receive optical radiation that is reflected from the target scene and to output electrical pulses in response to photons that are incident thereon. A second array of time-to-digital converters (TDCs) is configured to detect the electrical pulses that are output by respective groups of one or more of the single-photon detectors in each of a sequence of the sampling intervals in a succession of sampling frames and to output respective times of arrival of the electrical pulses in each of the sampling frames relative to the optical pulses. Each sampling frame contains a second number m of the sampling intervals such that p and m are co-prime. Control logic is configured to receive and aggregate the times of arrival output by the TDCs into a respective histogram of times of flight of the optical pulses received by each of the groups of the single-photon detectors.

In a disclosed embodiment, the single-photon detectors include single-photon avalanche diodes (SPADs).

Additionally or alternatively, the control logic is configured to aggregate the times of arrival over multiple image frames, each image frame including P successive pulses in the series, to generate the respective histogram for each of the groups, such that P is an integer multiple of m.

In some embodiments, the control logic is configured to drive the radiation source to output a first series of the optical pulses at a first PRI equal to p1 sampling intervals and a second series of the optical pulses at a second PRI equal to p2 sampling intervals, such that both p1 and p2 are co-prime with respect to m, and p1≠p2. In one embodiment, the radiation source is mounted in proximity to a radio receiver, which is configured to receive signals in an assigned frequency band, and p1 and p2 are selected such that the first and second PRIs have no harmonics within the assigned frequency band.

Additionally or alternatively, the control logic includes a clock generator, which is configured to generate the sample clock to define the sampling intervals, and a PRI generator, which is configured to trigger the radiation source following each p sampling intervals. A PRI counter is configured to output a PRI start code of each of the optical pulses indicating the sampling intervals in which the optical pulses were triggered. The TDCs are coupled to find the times of arrival of the electrical pulses in each of the sampling frames responsively to the sample clock and the PRI start code. In a disclosed embodiment, each of the TDCs includes a sample counter, which is configured to generate sample counts indicative of the respective sampling intervals in which the electrical pulses were detected, and a subtracter, which is configured to output the times of arrival of the electrical pulses responsively to a difference between the sample counts and the PRI start code in each of the sampling frames.

There is also provided, in accordance with an embodiment of the invention, a method for optical sensing, which includes directing a series of optical pulses toward a target scene with a pulse repetition interval (PRI) equal to a first number p of sampling intervals defined by a sample clock. Electrical pulses output by an array of single-photon detectors are received in response to photons of optical radiation that are reflected from the target scene and are incident on the single-photon detectors. Respective times of arrival of the electrical pulses that are output by respective groups of one or more of the single-photon detectors are output in each of a sequence of the sampling intervals in a succession of sampling frames. Each sampling frame contains a second number m of the sampling intervals such that p and m are co-prime. The times of arrival are aggregated into a respective histogram of times of flight of the optical pulses received by each of the groups of the single-photon detectors.

The present invention will be more fully understood from the following detailed description of the embodiments thereof, taken together with the drawings in which:

### BRIEF DESCRIPTION OF THE DRAWINGS

FIG. 1 is a schematic side view of depth mapping apparatus, in accordance with an embodiment of the invention;

FIG. 2 is a block diagram showing details of sensing circuits and processing circuits, in accordance with an embodiment of the invention;

FIG. 3 is a block diagram showing implementation details of time-to-digital converters (TDCs), in accordance with an embodiment of the invention;

FIG. 4 is a timing diagram showing signals that are applied to TDCs and to a radiation source, in accordance with an embodiment of the invention;

FIG. 5 is a signal timing diagram that schematically illustrates time of flight (TOF) measurements, in accordance with another embodiment of the invention; and

FIG. 6 and FIG. 7 are tables showing pulse repetition intervals that can be used for sensing TOF, in accordance with embodiments of the invention.

### DETAILED DESCRIPTION

### Overview

To measure the time of flight at each pixel of a depth map in a direct TOF system, such as in the above-mentioned U.S. Patent Application Publication 2022/0244391, control logic finds the peak or peaks of the histogram that is constructed by the counters. When there is substantial differential nonlinearity (DNL) of the time-to-digital converters (TDCs), however, the peak location may be distorted or masked by artifacts. This sort of DNL can arise, for example, when the widths and/or start times of the TDC phases vary from their nominal, uniform design values. (The duration of such a phase is also referred to as the sampling interval or as the bin width of the corresponding histogram bin.) Variations of these sorts can arise, for example, due to process nonuniformities and/or differing trace lengths in the integrated circuit chip on which the counters and associated circuits are formed. Even small amounts of DNL can cause significant distortion in the measured time of flight, particularly in environments in which ambient light gives rise to a high background level in the output of the detectors.

U.S. Patent Application Publication 2022/0244391 describes a number of approaches to compensate for DNL among the bins of the histogram. In one approach, compensation is achieved by dithering the temporal offset between the optical pulses that are used to illuminate the target scene and the gating intervals that are applied to the counters. The dither is chosen so that over a sequence of image frames, counts associated with any given time of flight are aggregated in multiple different bins. The counts are summed over multiple frames while compensating for the dithered temporal offset, with the result that DNL among the counters is averaged out and thus canceled.

Another problem arises when the depth sensing apparatus is incorporated in a mobile communication device, such as a smartphone: The mobile communication device comprises at least one radio transceiver (and often multiple radio transceivers), which communicates over the air by receiving signals in an assigned frequency band, for example a cellular communication band. Meanwhile, the sequences of short, intense current pulses that are used to drive the radiation source at high pulse repetition frequency give rise to harmonics, some of which may fall within the assigned frequency band of the transceiver. The noise due to these harmonics can degrade the signal/noise ratio (SNR) of the radio transceiver.

The above-mentioned U.S. Pat. No. 11,500,094 describes a solution to this problem, based on identifying a permitted range of the PRIs in a manner that avoids interference with the assigned frequency band of the radio transceiver. The PRI values applied by the depth mapper are chosen to be within this permitted range. The permitted range is typically defined, in other words, so that the PRIs in the permitted range will have no harmonics within the assigned frequency band.

When temporal offset dithering is used to mitigate DNL in the depth mapper, however, each dither causes a momentary distortion in the PRI, which in turn gives rise to its own set of harmonics. Even if the PRI itself has no harmonics in the radio band of concern, the additional distortion harmonics are liable to cause interference.

Embodiments of the present invention that are described herein address this problem by compensating for DNL while maintaining a constant PRI, without dithering between the laser pulses and the histogram bins. To compensate for DNL, the PRI is chosen to be different from the duration of the sampling frames that are used in counting the pulses output by the single-photon detectors, so that over a succession of sampling frames, for any given time of flight, the corresponding pulses will be distributed over different sampling intervals in different sampling frames. Specifically, by choosing a PRI whose duration, in sampling intervals, is co-prime relative to the number of sampling intervals in a sampling frame, the pulses for any given time of flight will be distributed evenly over all the sampling intervals, thus averaging out the DNL in conversion of the times of the pulses to corresponding digital values (time-to-digital conversion). Apparatus of this sort is able to achieve sub-picosecond accuracy in measuring time of flight without the risk of radio interference caused by dithering.

Thus, in the disclosed embodiments, a radiation source directs a series of optical pulses toward a target scene with a pulse repetition interval (PRI) equal to a number p of sampling intervals defined by a sample clock. An array of single-photon detectors, such as SPADs, receive the optical radiation that is reflected from the target scene and outputs electrical pulses in response to the incident photons. An array of time-to-digital converters (TDCs) detect the electrical pulses that are output by respective groups of the single-photon detectors in each of a sequence of sampling intervals in a succession of sampling frames. (Each such group may contain either a single detector or multiple neighboring detectors, to give a larger effective pixel size.)

The TDCs output respective times of arrival of the electrical pulses in each sampling frame relative to the corresponding optical pulse. As noted above, each sampling frame contains a number m of sampling intervals, such that p and m are co-prime. Control logic receives and aggregates the times of arrival output by the TDCs into histograms of the times of flight of the optical pulses received by each of the groups of the single-photon detectors.

### System Description

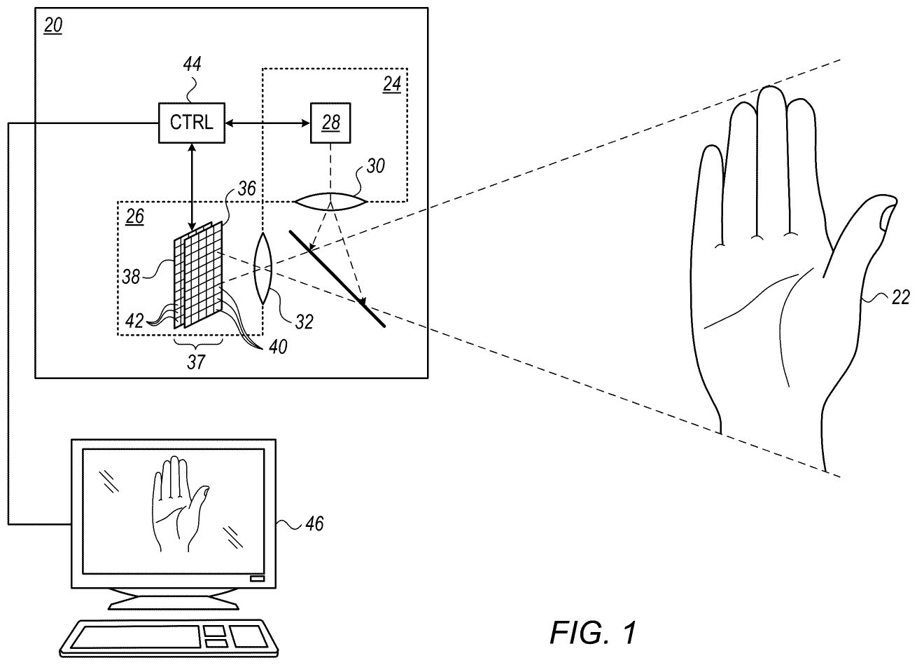

FIG. 1 is a schematic side view of depth mapping apparatus 20, in accordance with an embodiment of the invention. In the pictured embodiment, apparatus 20 is used to generate depth maps of an object 22, for example a part of the body of a user of the apparatus. To generate the depth map, an illumination assembly 24 directs pulses of light toward object 22, and an imaging assembly 26 captures the photons reflected from the object. (The terms “light” and “illumination,” as used in the present description and in the claims, refer to optical radiation, which may be in any of the visible, infrared, and ultraviolet ranges; and pulses of light are equivalently referred to as “optical pulses.”)

Illumination assembly 24 typically a comprises radiation source 28, such as at least one pulsed laser, which emits short pulses of light, with pulse duration in the picosecond to nanosecond range and high repetition frequency, for example 25 MHz or more. Collection optics 30 direct the light toward object 22. Alternatively, other source configurations, pulse durations and repetition frequencies may be used, depending on application requirements. For example, illumination assembly 24 may emit multiple pulsed beams of light along different, respective axes, so as to form a pattern of spots on object 22. In this case, although the spatial resolution of apparatus 20 in the transverse plane may be reduced, the depth resolution can be enhanced by concentrating the histogram capture and processing resources of imaging assembly 26 in the areas of the spots.

Imaging assembly 26 comprises objective optics 32, which image object 22 onto a sensing array 37, so that photons emitted by illumination assembly 24 and reflected from object 22 are incident on the sensing array. In the pictured embodiment, sensing array 37 comprises sensing circuits 36 and ancillary circuits 38. Sensing circuits 36 comprises an array of single-photon detectors 40, such as SPADs, each of which outputs electrical pulses indicative of the time of incidence of a single photon on the sensing element. Ancillary circuits 38 comprise an array of processing circuits 42, including time-to-digital converters (TDCs), which are coupled to the sensing elements, as described in detail hereinbelow.

Circuits 36 and 38 are disposed on a semiconductor substrate, which may comprise a single chip or two or more separate chips coupled together, for example using chip stacking techniques that are known in the art. Circuits 36 and 38 may be formed on one or more silicon wafers using well-known CMOS fabrication processes, based on SPAD sensor designs that are known in the art, along with accompanying counters and logic as described hereinbelow. Alternatively, the designs and principles of detection that are described herein may be implemented, mutatis mutandis, using other materials and processes. All such alternative implementations are considered to be within the scope of the present invention.

Apparatus 20 is timed to capture TOF information continually over a series of image frames. In each image frame, processing circuits 42 detect times of flight of photons that are incident on detectors 40 in multiple sampling frames and store the corresponding TDC values in data registers. In this manner, processing circuits 42 generate respective histogram data for each of a matrix of pixels that is defined by the array of the single-photon detectors 40. The pixels may be “super-pixels,” defined by grouping together a number of the detectors and aggregating the histogram over the entire group, as noted above.

A system controller 44 reads out the TDC values from processing circuits 42 and aggregates the values into respective histograms of times of flight of the optical pulses received by each of the groups of the single-photon detectors. Controller 44 extracts the histogram peaks for each pixel and generates an output depth map, comprising the measured TOF—or equivalently, the measured depth value—at each pixel. The depth map may be conveyed to a receiving device 46, such as a display or a computer or other processor, which segments and extracts high-level information from the depth map.

System controller 44 typically comprises a programmable processor, such as a microprocessor or embedded microcontroller, which is programmed in software or firmware to carry out the functions that are described herein. This software or firmware may be stored in tangible, non-transitory computer-readable media, such as optical, magnetic, or electronic memory media. Alternatively or additionally, at least some of the processing functions of controller 44 may be carried out by hard-wired or programmable digital logic circuits. System controller 44 is a part of the control logic that controls the operation and processes the output of apparatus 20, together with drive and readout circuits in sensing array 37 and with the processing and readout circuits that are described further hereinbelow.

### DNL Compensation Circuits and Timing

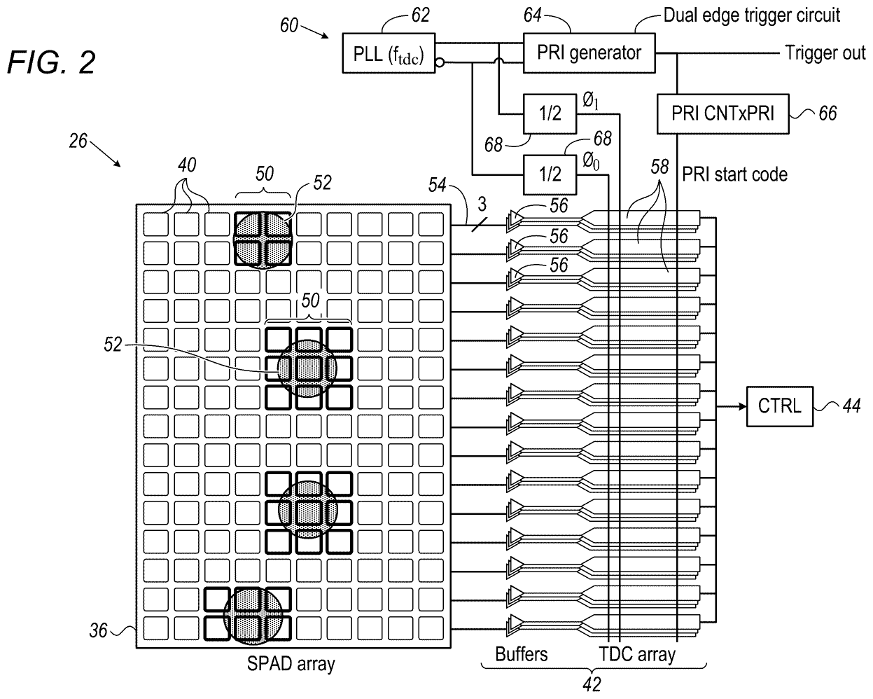

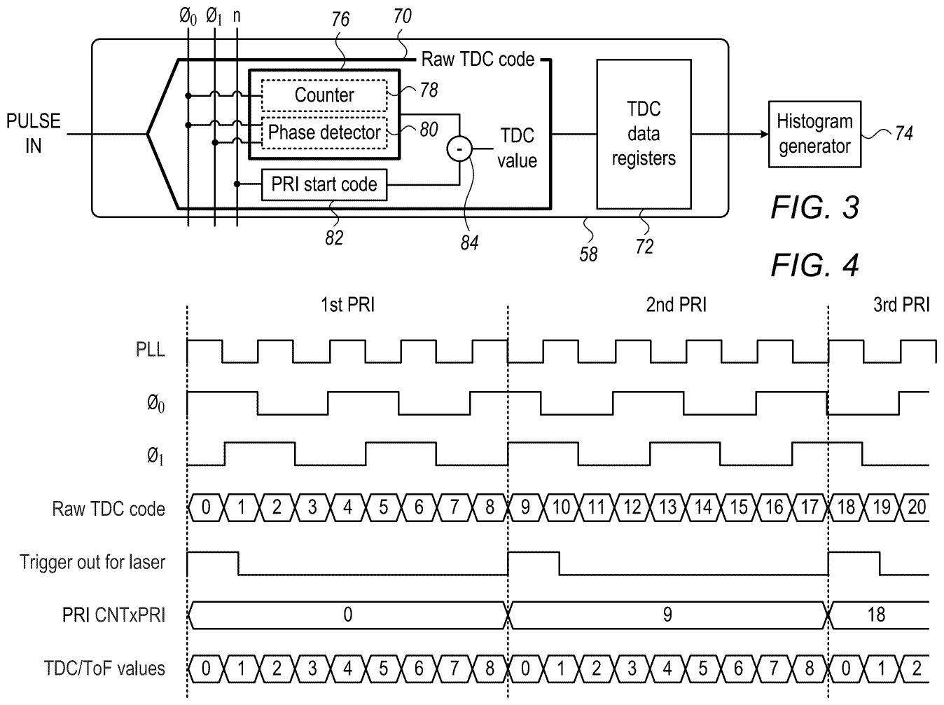

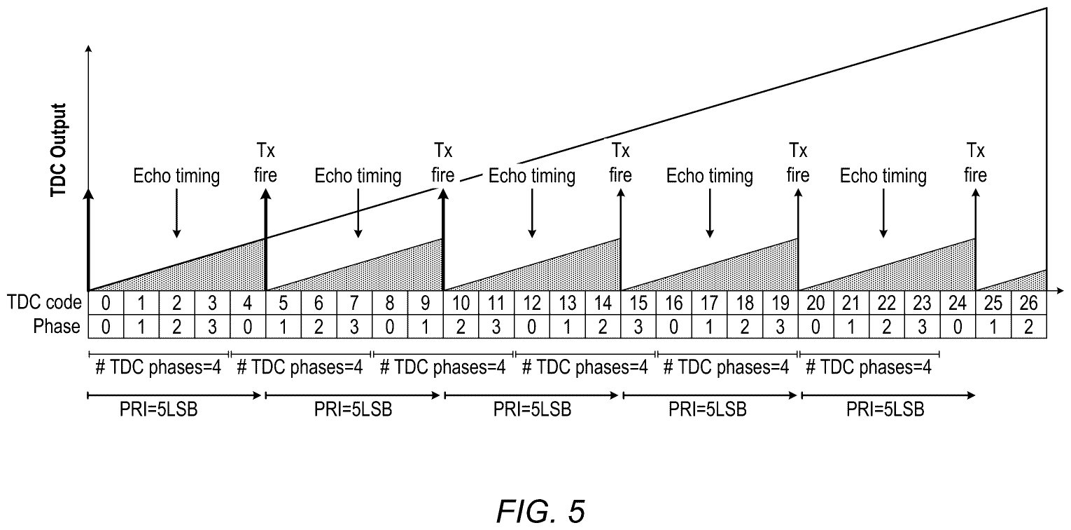

Reference is now made to FIGS. 2-4, which schematically illustrate the structure and operation of imaging assembly 26, in accordance with an embodiment of the invention. FIG. 2 is a block diagram showing details of sensing circuits 36 and processing circuits 42, including an array of TDCs 58. FIG. 3 is a block diagram showing implementation details of TDCs 58, while FIG. 4 is a timing diagram showing signals that are applied to the TDCs, as well as to radiation source 28. In this example, each sampling frame contains m=4 sampling intervals (also referred to as TDC phases), while the PRI is equal to p=9 sampling intervals. Alternatively, other choices of PRI and sampling frame size can be used, subject to the condition that p and m are co-prime.

Detectors 40 in this embodiment are grouped into super-pixels 50, on which respective spots 52 of light reflected from object 22 are focused. The electrical pulses output by each of detectors 40 in super-pixels 50 are conveyed by signal buses 54 to respective buffers 56, which input the pulses to an array of TDCs 58. In other words, in each row of the SPAD array, switching logic (not shown) selects up to three detectors 40, on which spots 52 are incident, and each of the selected detectors is coupled to a respective TDC. This sort of embodiment can be advantageous in enhancing the spatial resolution of the depth map. The TDCs output digital values to controller 44, indicating the times of arrival of the electrical pulses following each optical pulse generated by illumination assembly 24.

In an alternative embodiment (not shown in the figures), each TDC 58 is coupled to a respective row of the array of detectors 40, and the switching logic selects the detectors in super-pixels 50 for output to the TDCs. This approach is advantageous in reducing chip area and power consumption.

Timing control logic 60 generates timing signals for controlling TDCs 58, as well as a trigger output to trigger radiation source 28 to generate optical pulses. For these purposes, a clock generator 62, such as a phase-locked loop (PLL), generates a sample clock for input to the TDCs. In this example each clock cycle produces two sampling intervals (one starting on the rising edge of the clock, and the other on the falling edge). A PRI generator 64 generates a trigger output pulse to trigger the radiation source following each p sampling intervals. In addition, a PRI counter 66 outputs a PRI start code for each of the optical pulses, indicating the sampling interval in which the most recent optical pulse was triggered. The PRI start code n is equal to the p times the trigger pulse count, i.e., n=PRI_CNT×PRI.

TDCs 58 find the times of arrival of the electrical pulses in each of the sampling frames based on the sample clock and the PRI start code. To define the sampling frames, phase generators 68 output respective phase signals ϕ₀ and ϕ₁, at relative phases of 0° and 90°. Two phase generators of this sort are sufficient for m=4. Alternatively, other phase generator configurations may be used to generate longer sampling frames.

As shown in FIG. 3, each TDC 58 comprises a TDC code generator 70, which generates a TDC value indicating the time of arrival of each electrical pulse received from the corresponding detector 40. The TDC value is in the range {0, 1, . . . , p-1}, as illustrated in the last row in FIG. 4. The TDC values are stored in TDC data registers 72. The stored TDC values are then output to histogram generation logic 74, which may be implemented, for example, as a suitable hardware or software processing component of controller 44.

To average out the DNL of TDC code generators 70, the TDC values are aggregated over one or more image frames. Each such image frame contains P trigger pulses generated by PRI generator 64 (and hence P optical pulses directed toward the target scene), wherein P is an integer multiple of the sampling frame duration m. Typically, histogram generation logic 74 aggregates TDC data over many image frames of this sort to generate an accurate histogram for each super-pixel 50 (or each individual pixel) in the detector array.

Each TDC code generator 70 comprises a sample counter 76, which generates a sample count indicative of the respective sampling interval in which each electrical pulse was detected. Sample counter 76 comprises a frame counter 78, which counts the number of sampling frames that have elapsed in the current image frame, and a phase detector 80, which counts the sampling intervals that have elapsed in the current sampling frame. Based on these counts, sample counter 76 generates a raw TDC code, which is equal to the sample count for each detected electrical pulse, as illustrated in FIG. 4. A PRI start code detector 82 decodes the PRI start code n, and a subtracter 84 subtracts the PRI start code from the raw TDC code to give the TDC value. In other words, subtracter 84 outputs the times of arrival of the electrical pulses based on the difference between the sample counts and the PRI start code in each of the sampling frames.

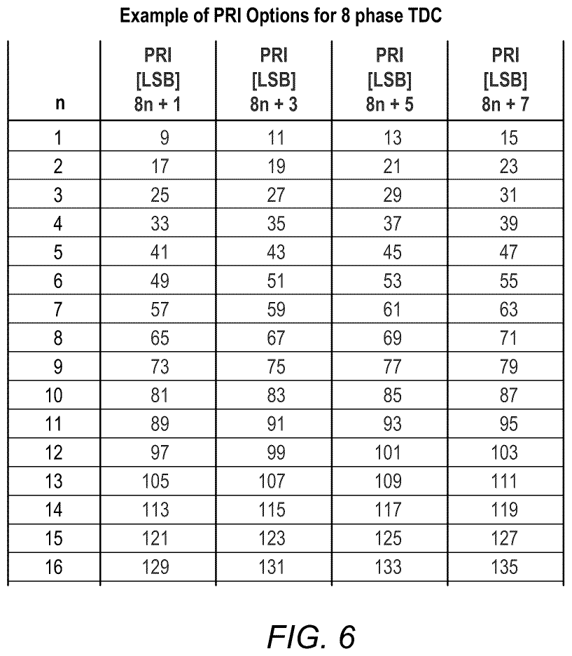

FIG. 5 is a signal timing diagram that schematically illustrates TOF measurements using the approach described above, in accordance with another embodiment of the invention. In this case, p=5, while m=4. (The four sampling intervals in each sampling frame are referred to in the drawing as “TDC phases.”) Following each outgoing optical pulse (marked “Tx fire”), the optical radiation reflected from the target scene (marked “Echo timing”) arrives in a different TDC phase, despite occurring at a constant delay of two sampling intervals relative to the optical pulse. Thus, DNL among the sampling intervals averages out over the sequence of pulses.

A wide variety of different combinations of PRI (p) and sampling frame length (m) can be used, depending on application requirements. The formula p=nm+k, wherein n and k are positive integers, can be used to generate suitable combinations of co-prime p and m, with p>m, as long as m and k have no common factors greater than 1.

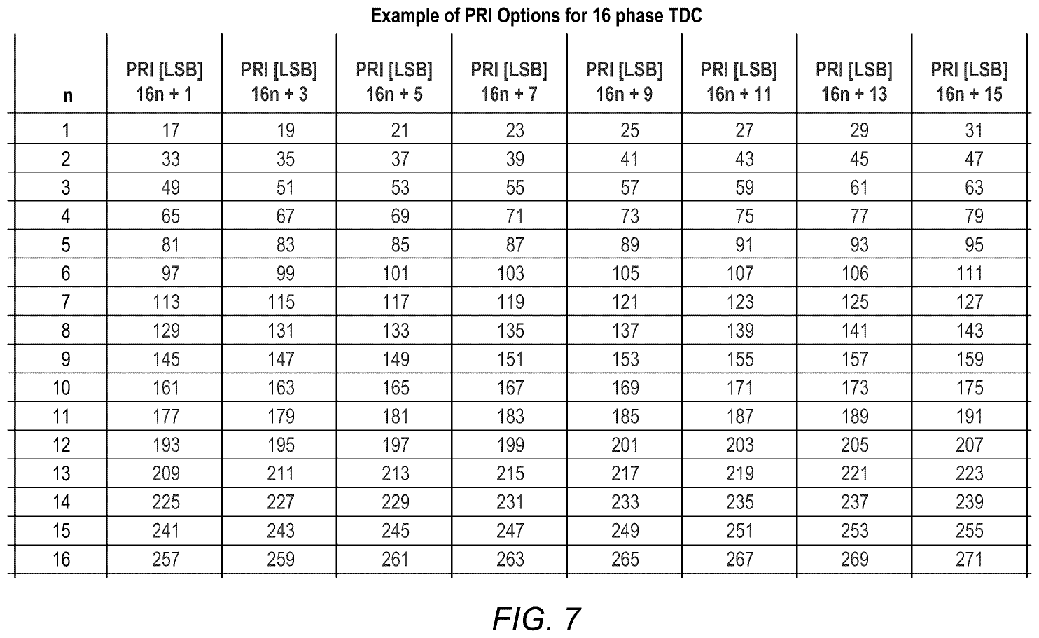

FIGS. 6 and 7 are tables showing possible values of p computed on this basis, in accordance with an embodiment of the invention. In FIG. 6, the number of sampling intervals m=8, while in FIG. 7, m=16. As noted earlier, for DNL cancellation, the number of optical pulses P fired in each image frame should be a multiple of m.

In some embodiments, controller 44 may apply multiple different values of PRI in alternation, for example to facilitate disambiguation of range folding (as explained in the above-mentioned U.S. Pat. No. 11,500,094). Thus, controller 44 may drive radiation source 28 to output a first series of optical pulses at a first PRI equal to p1 sampling intervals, followed by a second series of optical pulses at a second PRI equal to p2 sampling intervals. Both p1 and p2 are co-prime with respect to m, and p1≠p2. When the radiation source is mounted in proximity to a radio receiver (not shown), which receives signals in an assigned frequency band, both p1 and p2 can be selected such that the first and second PRIs have no harmonics within the assigned frequency band.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Optical sensing apparatus, comprising:
a radiation source, which is configured to direct a series of optical pulses toward a target scene with a pulse repetition interval (PRI) equal to a first number p of sampling intervals defined by a sample clock;
a first array of single-photon detectors, which are configured to receive optical radiation that is reflected from the target scene and to output electrical pulses in response to photons that are incident thereon;
a second array of time-to-digital converters (TDCs), which are configured to detect the electrical pulses that are output by respective groups of one or more of the single-photon detectors in each of a sequence of the sampling intervals in a succession of sampling frames, each sampling frame containing a second number m of the sampling intervals such that p and m are co-prime, and to output respective times of arrival of the electrical pulses in each of the sampling frames relative to the optical pulses; and
control logic, which is configured to receive and aggregate the times of arrival output by the TDCs into a respective histogram of o times of flight of the optical pulses received by each of the groups of the single-photon detectors.

2. The apparatus according to claim 1, wherein the single-photon detectors comprise single-photon avalanche diodes (SPADs).

3. The apparatus according to claim 1, wherein the control logic is configured to aggregate the times of arrival over multiple image frames, each image frame comprising P successive pulses in the series, to generate the respective histogram for each of the groups, such that P is an integer multiple of m.

4. The apparatus according to claim 1, wherein the control logic is configured to drive the radiation source to output a first series of the optical pulses at a first PRI equal to p1 sampling intervals and a second series of the optical pulses at a second PRI equal to p2 sampling intervals, such that both p1 and p2 are co-prime with respect to m, and p1≠p2.

5. The apparatus according to claim 4, wherein the radiation source is mounted in proximity to a radio receiver, which is configured to receive signals in an assigned frequency band, and wherein p1 and p2 are selected such that the first and second PRIs have no harmonics within the assigned frequency band.

6. The apparatus according to claim 1, wherein the control logic comprises:
a clock generator, which is configured to generate the sample clock to define the sampling intervals;
a PRI generator, which is configured to trigger the radiation source following each p sampling intervals; and
a PRI counter, which is configured to output a PRI start code of each of the optical pulses indicating the sampling intervals in which the optical pulses were triggered,
wherein the TDCs are coupled to find the times of arrival of the electrical pulses in each of the sampling frames responsively to the sample clock and the PRI start code.

7. The apparatus according to claim 6, wherein each of the TDCs comprises:
a sample counter, which is configured to generate sample counts indicative of the respective sampling intervals in which the electrical pulses were detected; and
a subtracter, which is configured to output the times of arrival of the electrical pulses responsively to a difference between the sample counts and the PRI start code in each of the sampling frames.

8. A method for optical sensing, comprising:
directing a series of optical pulses toward a target scene with a pulse repetition interval (PRI) equal to a first number p of sampling intervals defined by a sample clock;
receiving electrical pulses output by an array of single-photon detectors in response to photons of optical radiation that are reflected from the target scene and are incident on the single-photon detectors;
outputting respective times of arrival of the electrical pulses that are output by respective groups of one or more of the single-photon detectors in each of a sequence of the sampling intervals in a succession of sampling frames, each sampling frame containing a second number m of the sampling intervals such that p and m are co-prime; and
aggregating the times of arrival into a respective histogram of times of flight of the optical pulses received by each of the groups of the single-photon detectors.

9. The method according to claim 8, wherein the single-photon detectors comprise single-photon avalanche diodes (SPADs).

10. The method according to claim 8, wherein aggregating the times of arrival comprises forming an aggregation over multiple image frames, each image frame comprising P successive pulses in the series, to generate the respective histogram for each of the groups, such that P is an integer multiple of m.

11. The method according to claim 8, wherein directing the series of optical pulses comprises outputting a first series of the optical pulses at a first PRI equal to p1 sampling intervals and a second series of the optical pulses at a second PRI equal to p2 sampling intervals, such that both p1 and p2 are co-prime with respect to m, and p1≠p2.

12. The method according to claim 11, wherein the optical pulses are output by a radiation source in proximity to a radio receiver, which is configured to receive signals in an assigned frequency band, and wherein outputting the first and second series of the optical pulses comprises selecting p1 and p2 such that the first and second PRIS have no harmonics within the assigned frequency band.

13. The method according to claim 8, wherein aggregating the times of arrival comprises:
outputting a PRI start code of each of the optical pulses indicating the sampling intervals in which the optical pulses were triggered; and
finding the times of arrival of the electrical pulses in each of the sampling frames responsively to the sample clock and the PRI start code.

14. The method according to claim 13, wherein outputting the respective times of arrival comprises:
generating sample counts indicative of the respective sampling intervals in which the electrical pulses were detected; and
outputting the times of arrival of the electrical pulses responsively to a difference between the sample counts and the PRI start code in each of the sampling frames.
